(19) United States
(12) Patent Application Publication
(10) Pub. No.: US 2016/0042093 A1
(43) Pub. Date: Feb. 11, 2016

(54) Leveraging Data Searches in a Document

(71) Applicant: Microsoft Corporation, Redmond, WA (US)

(72) Inventors: Benjamin Edward Rampson, Woodinville, WA (US); Poornima Hanumara, Seattle, WA (US); Christopher John Gross, Redmond, WA (US); Anupam Garg, Sammamish, WA (US); Kevin Lane Brown, Woodinville, WA (US)

(21) Appl. No.: 14/453,086

(22) Filed: Aug. 6, 2014

(51) Int. Cl. G06F 17/30

(52) U.S. Cl. CPC G06F 17/30997; G06F 17/30867; G06F 17/30339

(57) ABSTRACT

Technologies are described herein for leveraging data searches in documents. The technologies disclosed herein may be utilized to search one or more data stores to retrieve metadata relating to data entered in a document. The metadata may be used to identify relationships between the data or to identify other aspects of the data. The metadata may also be used to organize the data into a format such as a pivot table or chart.

### BACKGROUND

Creating a table or a pivot table in a word processing or spreadsheet document can be a complex and arduous process. Even for users that know how to do advanced analysis using data, the number of steps typically required to create a table or a pivot table can be high. For novice users, discovering and learning how to perform these tasks can be especially difficult.

Some current applications may implement a user interface that provides recommendations for tables and pivot tables. These user interfaces may, however, be limited in the functionality that they provide.

It is with respect to these and other considerations that the disclosure made herein is presented.

### SUMMARY

Technologies are described herein for leveraging data searches in a document. Data received into a document may be analyzed to identify metadata associated with the data. The metadata may be used to annotate, organize and/or render the data in various formats, including, but not limited to, pivot tables, tables, charts, and the like. The metadata may be obtained by searching an internal or an external data store. An internal data store may include, but is not limited to, a data store associated with an organization that includes information about the organization. An external data store may include, but is not limited to, various data stores found using an Internet search engine.

In one example, an application may detect the entry of data into a document generated by the application, such as a spreadsheet document. The application may invoke a search module to analyze the entered data and identify one or more search terms for the entered data. The search module may use the search term, or terms, to perform a search on an organizational data store, a remote data store, or a combination thereof.

The search module may receive and analyze results of the search to identify metadata associated with the data. The metadata may include, but is not limited to, a description of the data (descriptive metadata) or information regarding the design and specification of the structure of the data (structural metadata). The application may analyze the metadata and render suggested labels or structures of the data.

In one specific example, the terms “WA,” “PA,” and “CA” may be entered into adjacent cells in a column of a spreadsheet document. A search using the terms “WA,” “PA,” and “CA” may return metadata that identifies the data as possible states or locations. In response to receiving this type of metadata, the application may analyze the metadata and render a “STATE” label in the document, such as in a column header for the column containing the terms.

In some implementations, the application may further identify a possible structure for the data. In the example given above, for instance, the entries for “WA,” “PA,” and “CA” may be re-organized, or moved, to be in a single column of data, thus further indicating their relationship as states under the “STATE” label.

In other implementations, the application may provide an option to generate a pivot table or other type of element based on, or using, the metadata. The pivot table may incorporate a portion of the data organized according to, or through the use, of the metadata. Continuing with the example presented immediately above, for instance, a pivot table may be generated using the “STATE” label, with the column of information being the entries, “WA,” “PA,” and “CA.” In this example, the metadata may also include sales information or other types of information for the states. The application might also create a sum of the sales data to complete the process of generating a pivot table.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an illustrative operating environment for the various technologies disclosed herein.

FIG. 2 is a flow diagram showing aspects of one method disclosed herein for leveraging data searches in a document.

FIGS. 3A-3C are user interface diagrams showing aspects of user interfaces for leveraging data searches in a document, according to various configurations disclosed herein.

FIGS. 4A-4C are user interface diagrams showing the use of descriptive and structural metadata obtained using a search.

FIG. 5 is a user interface diagram showing more than one suggested metadata implementation, according to one configuration described herein.

FIG. 6 is a user interface diagram showing the use of metadata obtained during a search to suggested missing data.

FIG. 7 is a user interface diagram showing a screen display in which metadata may be used to correct data.

FIG. 8 is a computer architecture diagram illustrating an illustrative computer hardware and software architecture for a computing system capable of implementing the technologies presented herein.

FIG. 9 is a diagram illustrating a distributed computing environment capable of implementing aspects presented herein.

FIG. 10 is a computer architecture diagram illustrating a computing device architecture capable of implementing aspects of the various technologies presented herein.

### DETAILED DESCRIPTION

The following detailed description is directed to technologies for leveraging data searches in a document. According to various implementations, technologies disclosed herein may be utilized to search one or more data stores to retrieve metadata relating to data entered in a document such as a word processing or spreadsheet document. The metadata may be used to identify relationships between the data or to identify other aspects of the data. The metadata may also be used to suggest organization of the data into a format such as a pivot table, a table or chart.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown, by way of illustration, specific configurations or examples. Referring now to the drawings, in which like numerals represent like elements throughout the several figures, aspects of technologies for leveraging data searches in a document will be presented.

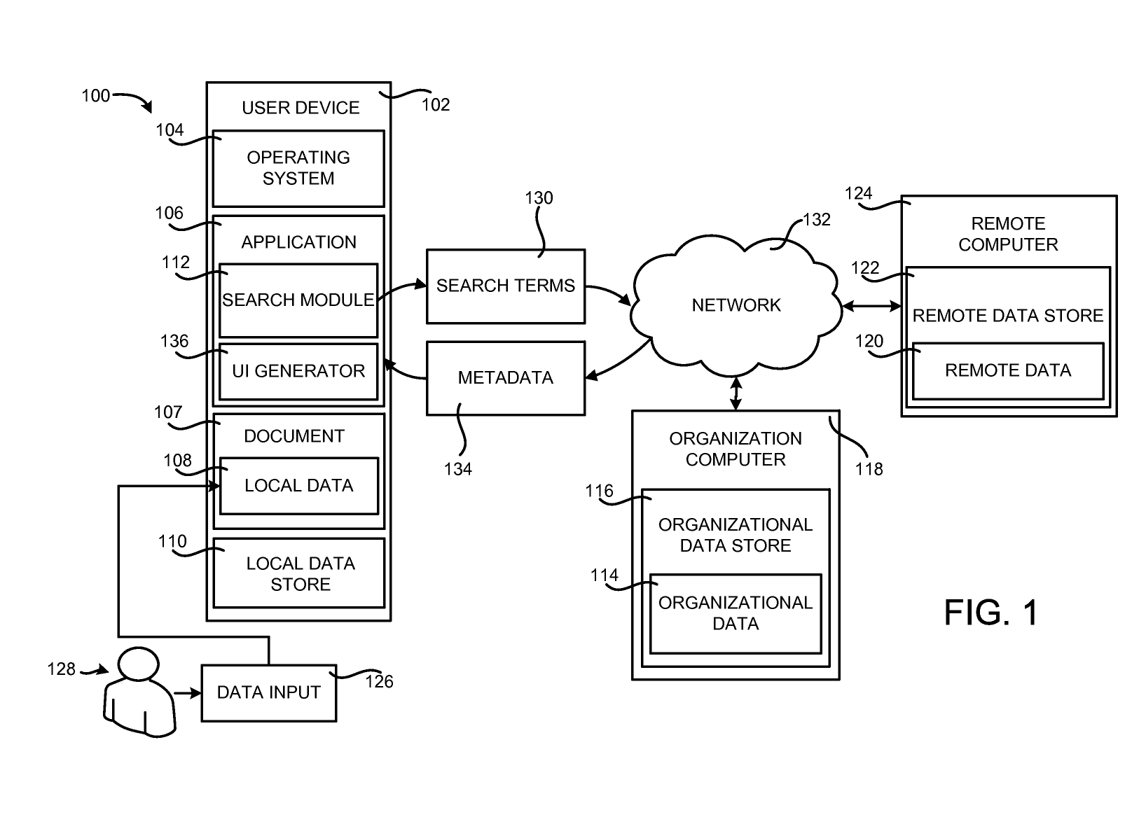

Referring now to FIG. 1, aspects of one operating environment 100 for the various technologies presented herein will be described. The operating environment 100 shown in FIG. 1 includes a user device 102. According to various configurations, the functionality of the user device 102 can be provided by a personal computer (“PC”) such as a desktop, tablet, or laptop computer system. In some other examples, the functionality of the user device 102 can be provided by other types of computing systems including, but not limited to, a handheld computer, a netbook computer, an embedded computer system, a mobile telephone, a smart phone, or another type of computing device.

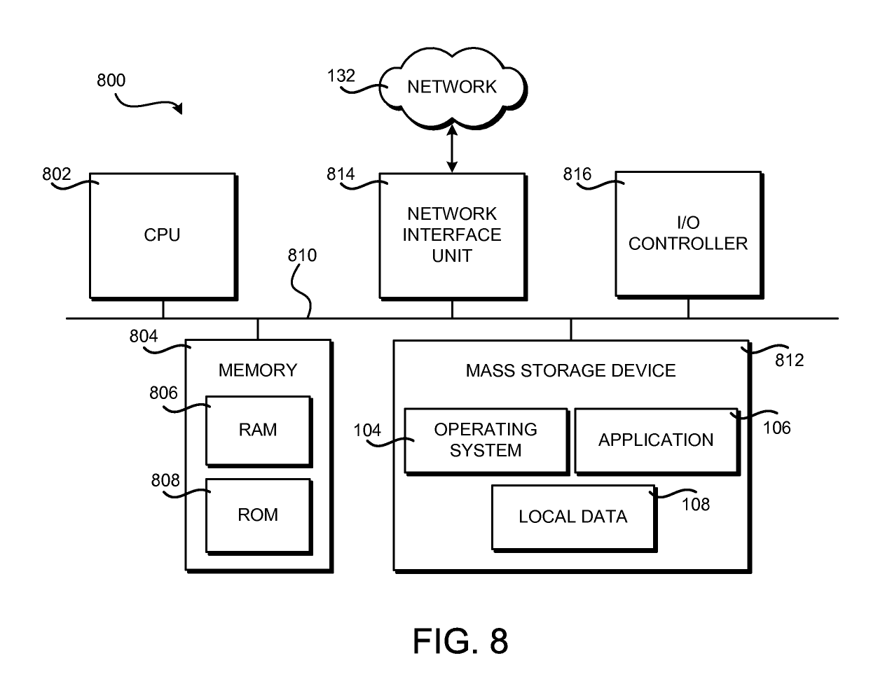

Various configurations for the user device 102 are illustrated and described below, particularly with reference to FIGS. 8-10. Although the configurations described herein are described primarily in the context of a user device 102 that is a tablet or slate computing device, a smartphone, or a personal computer, because the functionality described herein with respect to the user device 102 can be provided by additional and/or alternative devices, it should be understood that these configurations are illustrative, and should not be construed as being limiting in any way.

The user device 102 can be configured to execute an operating system 104 and an application 106. The operating system 104 is a computer program for controlling the operation of the user device 102. The application 106 is an executable program configured to execute on top of the operating system 104. The application 106 can provide various types of functions. According to various configurations, for instance, the application 106 may be a program such as, but not limited to, a spreadsheet program, a word processing program, and the like. The application 106 may be configured to generate a document 107.

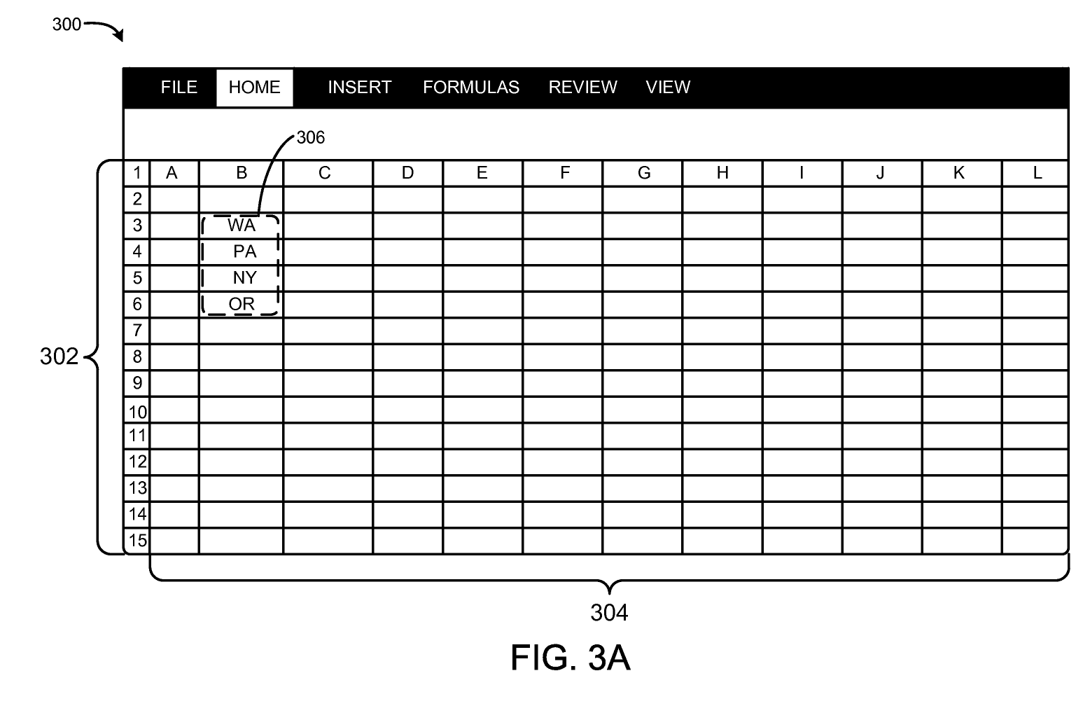

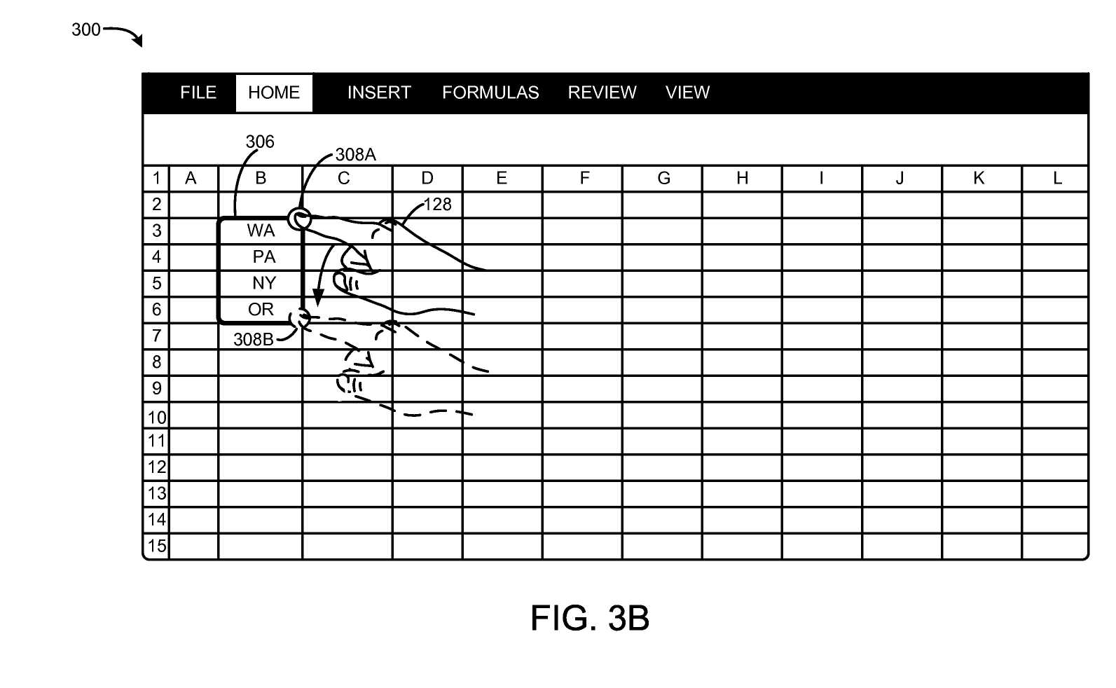

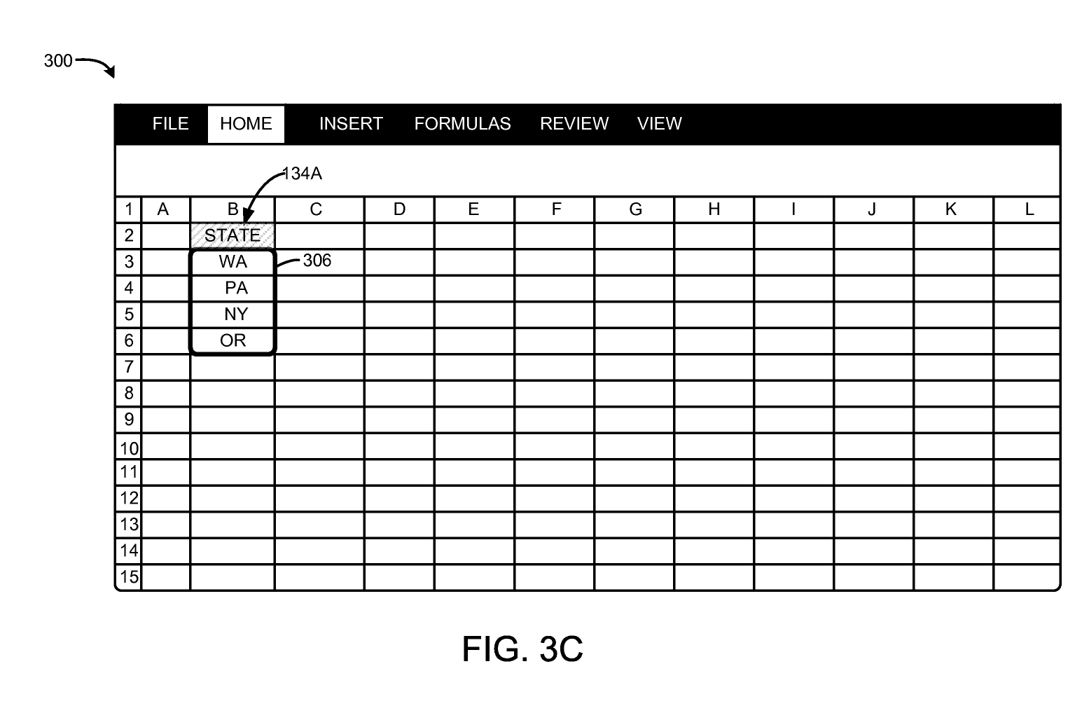

The application 106 can be configured to receive local data 108 for use in the document 107, to execute various operations with respect to the local data 108, and/or to render various views of the local data 108 in a user interface, such as the screen displays shown in FIGS. 3A-3C and described below. As used herein, “local” refers to data entered using the application 106 or rendered by the application 106. The local data 108 may include data input 126 by a user 128. The local data 108 may be stored, at least temporarily, in a local data store 110 or other data stores for use by the application 106.

According to various configurations, the local data 108 is data that may be used in a spreadsheet generated and/or readable by a suitable spreadsheet program, such as GOOGLE DOCS from Google Inc. in Mountain View, Calif., or NUMBERS for MAC from Apple Inc. in Cupertino, Calif. In other examples, the local data 108 corresponds to a HTML file, an XML file, other types of files, and/or various scripts such as, for example, JAVASCRIPT, and/or other web-based file formats or executable code that, when executed and/or rendered by the application 106, represent various files.

According to some configurations, the files represented by the local data 108 can include, but are not limited to, a file in a web-based format for representing spreadsheets, workbooks, tables, grids, or other types of files. Because the local data 108 can include data in the above-described formats, as well as others, it should be understood that the configurations described above are illustrative, and should not be construed as being limiting in any way. In one contemplated configuration, the local data 108 corresponds to spreadsheet data or data in other grid-based or tabular formats.

The application 106 may be configured to execute a search module 112. In some configurations, the application 106 may execute the search module 112 upon the initialization of the application 106, where the search module 112 executes in the background of the application 106. In another implementation, the search module 112 may analyze the local data 108 upon the receipt of an instruction to perform a search, such as a selection of a portion of the local data 108 in the document 107.

The search module 112 may perform various functions within the application 106. In one configuration, the search module 112 may receive an instruction to perform a search, analyze the local data 108, and execute a search on various data stores, such as the local data store 110, or on organizational data 114 stored in an organizational data store 116 associated with an organization computer 118. The organization computer 118, in some implementations, may be a central server or other computer in communication with the user device 102. The organization computer 118 and the user device 102 may be associated with each other as separate devices in a network of an organization, such as, but not limited to, a company or enterprise.

In another implementation, the search module 112 may cause a search to be executed on remote data 120 stored in a remote data store 122 maintained by a remote computer 124. The remote computer 124 may be any computer not part of an organization to which the user device 102 or the organization computer 118 belongs. For example, the remote computer 124 may be a computer accessible via the Internet, such as an Internet-based search engine. In another example, if the organization is a workgroup, the organization computer 118 and the user device 102 may be computers associated with the workgroup, whereas the remote computer 124 may be a computer associated with an organization to which the user device 102 and the organization computer 118 belongs but is outside the workgroup.

The search module 112 may be configured to analyze the local data 108 entered as data input 126 by a user 128 (or other entity or source). As a result of the analysis, the search module 112 may be configured to generate one or more search terms 130. The search terms 130 may vary depending on various factors associated with the data input 126 and/or the application 106. In one implementation, the search terms 130 may be a portion or all of the data input 126 that is selected or otherwise designated to be analyzed. In another implementation, the search terms 130 may be a derivative, summary, or amalgamation of at least a portion of the data input 126 that is selected or otherwise designated to be analyzed.

The search terms 130 may be transmitted through a network 132 to the remote computer 124 and/or the organization computer 118. The search terms 130 may be utilized to perform a search of the organization data 114 and/or the remote data 120 and to retrieve metadata 134 associated with the search terms 130. The metadata 134 may be descriptive metadata or may be structural metadata. As used herein, the term descriptive metadata refers to metadata returned from a search that provides a description of an aspect of the data. As used herein, the term structural metadata means metadata that provides information regarding the design or specification of the structure of the data.

In one specific example, using the search terms 130 “WA,” “PA,” and “CA,” the metadata 134 returned from a search may be descriptive metadata that describes the terms as “STATES.” In another specific example, using the search terms 130 “WA,” “PA,” “GA,” and “CA,” the metadata 134 returned from a search may be structural metadata that indicates that “WA” and “CA” should be grouped together (i.e. west coast states), while “PA” and “GA” should be grouped together (i.e. east coast states). These and other examples are merely illustrative, as the metadata 134 may be used in other ways or to perform various functions. In some examples, the search terms 130 may also include structural or organization information about the data input 126. In one specific example, the local data 108 may include two columns, a first column with the states, “WA, CA, and OR” and the second column with the states, “TX, AZ, ID.” The search terms 130 may include structural data regarding the column organization. The metadata 134 returned may indicate that the data in the first column are states that voted for one presidential candidate and the second column are states that voted for another presidential candidate. Without the structural data, the metadata 134 may just return “STATES.”

The application 106 may receive the metadata 134 from the remote computer 124 and/or the organizational computer 118 in response to performing a search, or searches. In response thereto, the application 106 may invoke a user interface (“UI”) generator 136. The UI generator 136 may present all or a portion of the metadata 134 in an appropriate UI. The UI generator 136 may also present all or a portion of the data input 126 in a manner that utilizes the metadata 134.

In one implementation, for instance, the UI generator 136 may display a portion of the local data 108 in another location in the document 107 rendered by the application 106. The UI generator 136 may organize or identify the portion of the local data 108 according to the metadata 134 received in response to the search. For example, the UI generator 136 may cause the terms “WA,” “PA,” “GA,” and “CA” to be rendered in a column of a worksheet if not already organized as such. The UI generator 136 may also cause a column header to be rendered for the column, such as the term “state,” based on the metadata 134. These and other aspects are illustrated and described below with reference to FIGS. 3A-3C, 4A-4C and 5.

FIG. 1 illustrates one user device 102, one network 132, one organization computer 118, and one remote computer 124. It should be understood, however, that some implementations of the operating environment 100 include multiple user devices 102, multiple networks 132, and/or multiple organization computers 118 and remote computers 124. The illustrated examples described above and shown in FIG. 1 should be understood as being illustrative, and should not be construed as being limiting in any way.

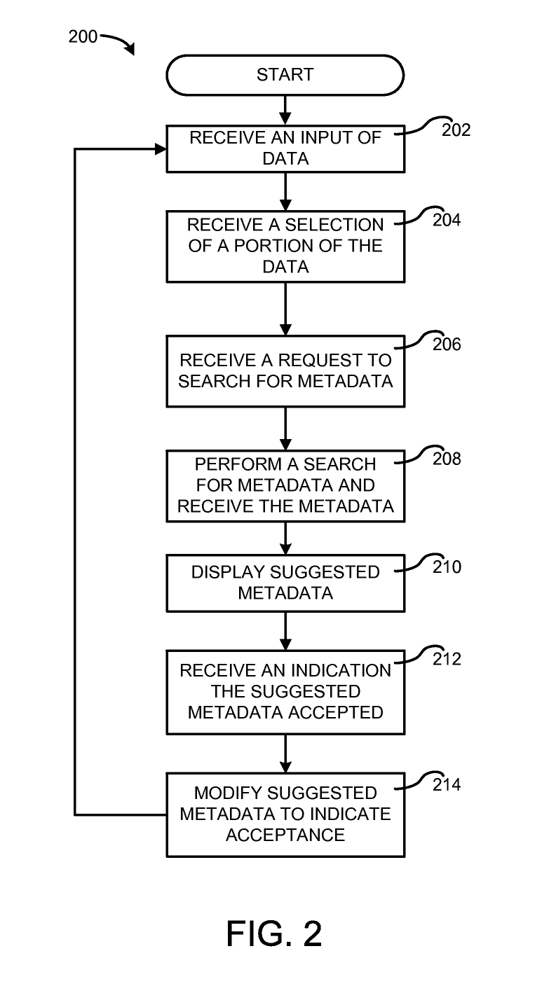

Turning now to FIG. 2, aspects of a method 200 for leveraging data searches in a document will be described in detail. It should be understood that the operations of the method 200 are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated method 200 can be ended at any time and need not be performed in its entirety. Some or all operations of the method 200, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein can be implemented as a sequence of computer implemented acts or program modules running on a computing system, and/or as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For purposes of illustrating and describing the concepts of the present disclosure, the method 200 disclosed herein is described as being performed by the user device 102 via execution of computer executable instructions such as, for example, the application 106. As explained above, the application 106 can include functionality for providing the search module 112 or the UI generator 136. As such, while the method 200 is described as being provided by the user device 102, it should be understood that the user device 102 can provide the functionality described herein via execution of various application program modules and/or elements. Additionally, devices other than, or in addition to, the user device 102 can be configured to provide the functionality described herein via execution of computer executable instructions other than, or in addition to, the search module 112 or the UI generator 136. As such, it should be understood that the described configuration is illustrative, and should not be construed as being limiting in any way.

The method 200 begins at operation 202, where the application 106, or components thereof, receives the data input 126. In some implementations, the data input 126 may be entered by the user 128. In other implementations, the data input 126 may be stored, at least temporarily, as the local data 108 in the local data store 110.

The application 106 may render at least a portion of the local data 108 in a document associated with the application 106. For example, the application 106 may be a spreadsheet program, whereby a portion of the local data 108 is displayed in a spreadsheet. In another example, the application 106 may be a word processing program, whereby a portion of the local data 108 is displayed in a page of a document generated by the application 106. The presently disclosed subject matter is not limited to any particular type of application or document.

The method 200 continues to operation 204, where a selection of a portion of the local data 108 displayed by the application 106 is received. The selection may be received using various technologies. Rather than requiring an explicit selection of local data 108, such as from a user, in one example, the application 106 may continuously analyze the local data 108 and automatically select a portion of the local data 108 based upon various criteria. In one implementation, a selection may be made in response to the application 106 recognizing that a portion of the data represents a complete listing of data. An example of this implementation may be the movement of data entry from one column in a spreadsheet to another. The application 106 may recognize that entry of data in a new column means that the data in the prior column is possibly a complete entry of data.

In another example, the application 106 may be configured to provide for the ability of the user 128 or other entity to select a portion of the local data 108. For example, and as illustrated by way of example in further detail in FIGS. 3A-3C, the user 128 may use a user input device (such as a mouse or touch screen) to select a portion of the local data 108. The application 106 may be configured to provide a means whereby the user 128 (or other entity) may indicate that the portion of the local data 108 selected (or highlighted) is the intended selection of the local data 108.

The method 200 continues to operation 206, where the application 106 receives a request to search for metadata 134 based upon the selected local data 108. In this regard, and as discussed above, the application 106 may be configured to execute the search module 112, or another module, to perform the search. The search module 112 may be configured to receive the selection of the data at operation 204 and identify one or more search terms 130 based thereupon. The search terms 130 may be transmitted to the organization computer 118 and/or the remote computer 124 for use in performing a search. The search terms 130 may take various forms according to various configurations. In one implementation, for example, the search terms 130 may be the selected data. In another implementation, the search terms 130 may be based upon the selected data.

In a further implementation, the search terms 130 may include one or more filters to define or refine the search to be performed. For example, if it is desirable to search for metadata 134 only in the organizational data store 116, the application 106 may be configured to include a filter, “Organization Computer,” as a limiter in the search terms 130. In this example, a search may be performed only on the organizational data 114 stored at the organization computer 118.

In another implementation, the metadata 134 may be filtered. For example, a filter to the metadata 134 may be applied, whereby only metadata from the organization computer 118 is accepted. In this example, metadata 134 received from the remote computer 124 may be filtered and not used by the application 106. The use of filters may be beneficial in various configurations. For example, the local data 108 may include financial data associated with a particular organization.

A filter may be applied to accept search results only from, or direct the search on, the organization computer 118. In one specific example, a filter may be applied to either the search terms 130 or the metadata 134 so that the metadata 134 is only received from the organization computer 118 and not the remote computer 124. This may help to ensure that the metadata 134 is more germane to the local data 108 than what may otherwise be the case if a more general search were performed. In some implementations, a search may be performed on the local data store 110 either solely or in combination with a search on the organization data store 116 and/or the remote data store 122.

The method 200 continues to operation 208, where a search for the metadata 134 is performed. The search may use the search terms 130 in various ways. In one implementation, the search may be performed using an Internet search engine. The Internet search engine may conduct a search using the search terms 130. The metadata 134 may be returned in various formats. The search module 112 may receive and analyze the metadata 134. For example, the search module 112 may analyze the search results of the Internet search engine and extract metadata from the search results. The application 106 may receive the metadata 134 from the search results, or may receive the metadata 134 from an analysis of the search results. In some implementations, a metadata confidence level may be returned. For example, an internet search engine may return two or more sets of the metadata 134. The search engine (or another component) may indicate a high confidence level with one set of the metadata 134 and various levels of confidence for the other sets of metadata 134.

The method 200 continues to operation 210, where the application 106 may display suggested metadata 134. The suggested metadata 134 may be metadata that is determined by the application 106 as a candidate to correctly identify, describe, or organize the selected data. The suggested metadata 134 may be more than one portion of the metadata 134, and may include multiple portions of the metadata 134.

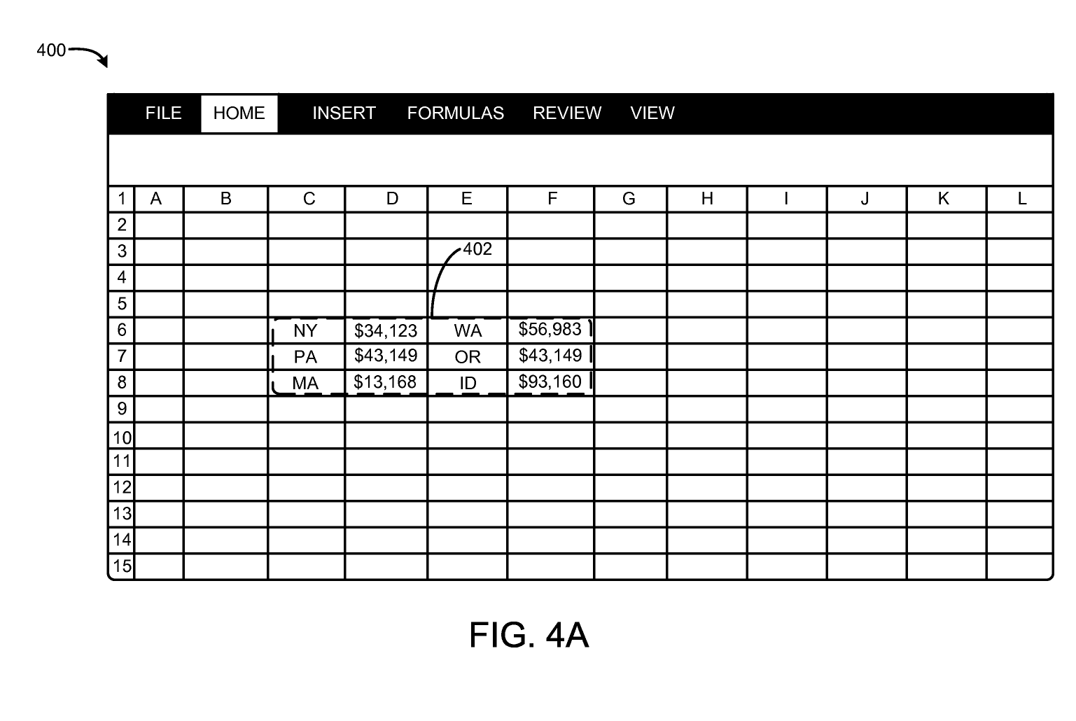

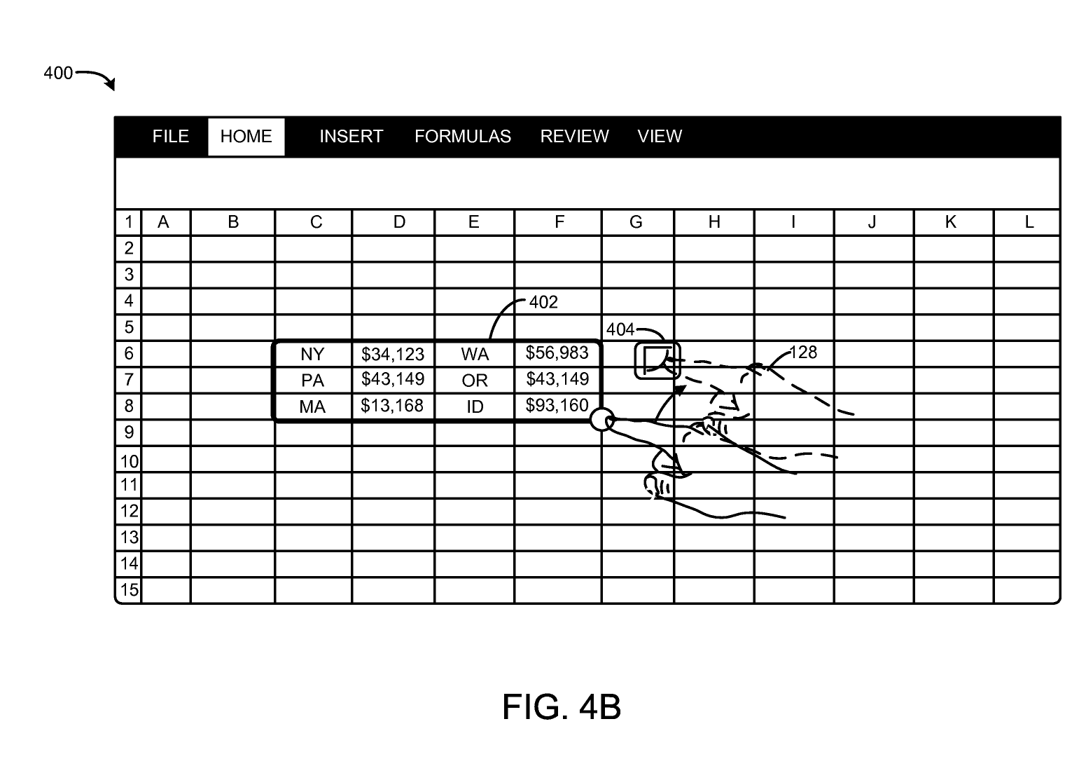

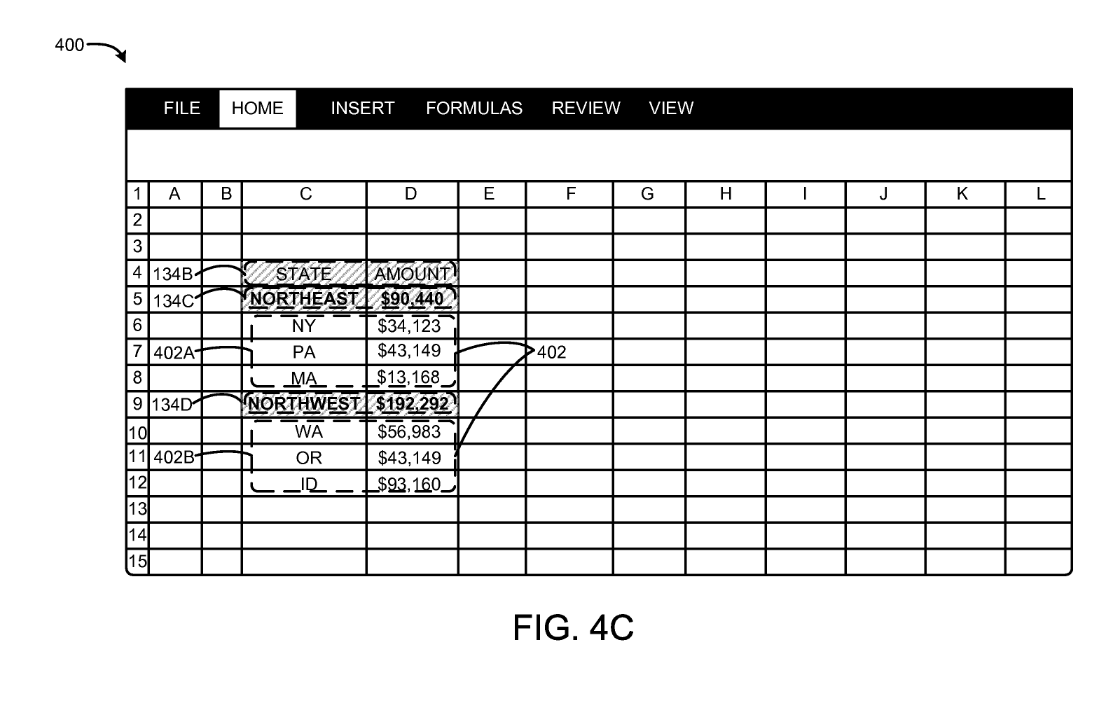

In one implementation, described in more detail in FIG. 4, below, the suggested metadata 134 may include multiple instances of metadata 134 that are selectable by the user 128. In some implementations, a confidence level in the metadata 134 may be used to order the suggested metadata 134.

The method 200 continues to operation 212, where an indication the suggested metadata 134 has been accepted is received. In some implementations, the suggested metadata 134 may be displayed in a format that indicates that the suggested metadata 134 has not been accepted. The application 106 may display a selection box or other means whereby the user 128 or other entity may indicate an acceptance of the suggested metadata 134. The suggested metadata 134 may be differentiated from other local data 108 using various display technologies. For example, the suggested metadata 134 may be displayed in shaded boxes, gray lettering, and the like.

The method 200 continues to operation 214, where the suggested metadata 134 is modified to indicate acceptance of the suggested metadata 134. The method 200 may continue or may end at various operations. As such, the method 200 can end or the method 200 can be repeated any number of times. Various implementations of the method described above with regard to FIG. 2 are described with reference to FIGS. 3A-3C, below. The technologies described in FIGS. 3A-3C may be implemented, in one configuration, by the user device 102.

Turning now to FIGS. 3A-3C, UI diagrams showing various aspects of the technologies disclosed herein for leveraging data searches in documents will be described according to various illustrative configurations. In particular, FIG. 3A shows an illustrative screen display 300 generated by a device such as the user device 102. As shown in FIG. 3A, the screen display 300 can include a representation of a spreadsheet generated by the application 106. In particular, the screen display 300 is illustrated as including a representation of a spreadsheet included in the local data 108. It should be understood that this configuration is illustrative, and should not be construed as being limiting in any way.

As shown in FIG. 3A, the screen display 300 can include rows 302 and columns 304. Data 306 may be displayed in the screen display 300. The data 306 may be received from various sources, including the local data store 110, the data input 126 from the user 128, the organizational data store 116, or the remote data store 122. The data 306 may also be data generated from other data (such as a function applied to other data). These and other examples are considered to be within the scope of the present disclosure.

As discussed above, the application 106 may receive an input, or may be configured to automatically determine, that an identification of at least a portion of the data 306 is requested. Thus, the application 106 may be configured to search for, and retrieve, descriptive metadata based upon the data 306. In another configuration, the application 106 may receive an input, or be configured to automatically determine, that the data 306 is to be placed in some order. Thus, the application 106 may be configured to search for, and retrieve, structural metadata based upon the data 306.

In FIG. 3B, the screen display 300 indicates that a user has selected the data 306. As discussed briefly above, the selection of the data 306 may be performed using various technologies. For instance, the technology illustrated in FIG. 3B utilizes a touch screen. Other suitable technologies might also be utilized.

In the example shown in FIG. 3B, the user 128 may select location 308A and move to location 308B. The application 106 may receive the input from location 308A to location 308B as an instruction to perform a search upon the data contained within the selection area. Other mechanisms might also be used to select a range of cells. For example, the user 128 may enter specific cells upon which a search is to be performed. In another example, the user 128 may selection a range of cells using a cursor controlled by a mouse. The presently disclosed subject matter is not limited to any particular input technology.

Upon the receipt of the selection of the data 306, the application 106 may invoke the search module 112. The search module 112 may determine one or more search terms 130 and search for metadata 134A to identify and/or lend structure to the data 306. The application 106 may receive the metadata 134A received from various sources, including, but not limited to, the organizational data store 116 and/or the remote data store 122.

In FIG. 3C, the screen display 300 indicates that the metadata 134A has been received and displayed proximate to the data 306. The metadata 134A returned may include the term, “STATE.” The metadata 134A may be used to describe the data 306 as states in this example. In one configuration, the metadata 134A may be displayed as a column header for the data 306.

In some configurations, the visual appearance of the metadata 134A may be used to indicate a suggested or temporary state. For example, the metadata 134A may be suggested metadata that is selectable by the user 128 or other entity. In this example, then, to indicate that the metadata 134A has not been selected, or approved, the metadata 134A may be visually differentiated from the data 306. Thus, as in the example illustrated in FIG. 3C, the metadata 134A may be shaded or have another visual effect applied thereto indicating that the user has not yet accepted the metadata 134A.

FIGS. 4A-4C are user interface diagrams showing the use of descriptive and structural metadata obtained using a search. As noted above, a search performed on the organizational data store 116 and/or the remote data store 122, depending on the particular configuration, may result in descriptive metadata, structural metadata, or a combination of both being returned. The use of the various types of metadata (including those not specifically delineated herein) may provide for the ability to identify and organize data.

Referring now to FIG. 4A, a screen display 400 indicates that data 402 has been entered. As noted above, the data 402 may be data stored locally at the local data store 110, the organizational data store 116, and/or the remote data store 122, or combinations thereof.

In FIG. 4B, the screen display 400 indicates that the data 402 has been selected by the user 128. In some implementations, the user 128 may request that the data 402 be placed in pivot table format. As noted above, a pivot table may be a data tool whereby operations on data are represented in a tabular format. In some configurations, a pivot-table can automatically sort, count a total or give an average of the data 402. The results of the operations may be displayed in a second table (called the “pivot table”).

To provide for the use of a pivot table feature provided by the application 106, the application 106 may render pivot table selector 404. The pivot table selector 404 may provide various functions. In the example illustrated in FIG. 4B, a user may select the data 402 and, thereafter, select the pivot table selector 404. The pivot table selector 404 may cause the application 106 to invoke the search module 112. The search module 112 may analyze the selected data 402 and determine one or more search terms 130 to search one or more data stores, such as the organizational data store 116 and/or the remote data store 122.

As noted above, the search terms 130 may include filters to search for, or return, data from certain sources. For example, the search terms 130 may include a filter to limit the search for metadata to the organizational data store 116. In this example, the data 402 may be sales data in some states. In some implementations, a search performed on a data store having little to no association with the data 402 may result in metadata having little to no value, as the metadata returned may be inapplicable or unrelated to the data 402. But, in one configuration, the search terms 130 may have a filter that limits the metadata to the organizational data store 116. Upon the execution of a search, the metadata returned may be relevant or applicable to the selected data 402.

In FIG. 4C, the screen display 400 indicates that structural and descriptive metadata has been received. For example, the data 402 has been rearranged as a result of the application of the structural metadata. As illustrated, the data 402, defining states with associated sales data, has been organized into two categories and has been identified based on the metadata. In another example, the data 402 may be left unarranged (as illustrated in FIG. 4A), and a new document (or data sheet) may be generated illustrating the data 402 as arranged in FIG. 4C.

In one example, the metadata 134B, “STATE” and “AMOUNT,” may be column headers that may identify the data 402 in each of the columns. In another example, the metadata 134C may be terms that provide a description of the organization of the data. In that example, the term “NORTHEAST” in the metadata 134C identifies the portion of the data 402 (identified as 402A) associated with states in the northeast portion of the United States. In a similar manner, the term “NORTHWEST” in the metadata 134D identifies the portion of the data 402 (identified as 402B) associated with states in the northwest portion of the United States.

The metadata 134B, 134C, or 134D may also indicate the results of various mathematical operations on the data 402. In the example illustrated in FIG. 4C, the metadata 134B indicates an “AMOUNT” as an identifier. In the metadata 134C, the amount for the states identified as being associated with NORTHEAST is “$90,440,” which indicates a total of sales for those states. In a similar manner, the metadata 134B indicates an “AMOUNT” as an identifier. In the metadata 134C, the amount for the states identified as being associated with NORTHEAST is “$192,292,” which indicates a total of sales for those states. The total amount may be performed as a result of a calculation on the data 402 or may be retrieved from a data store, such as the organizational data store 116.

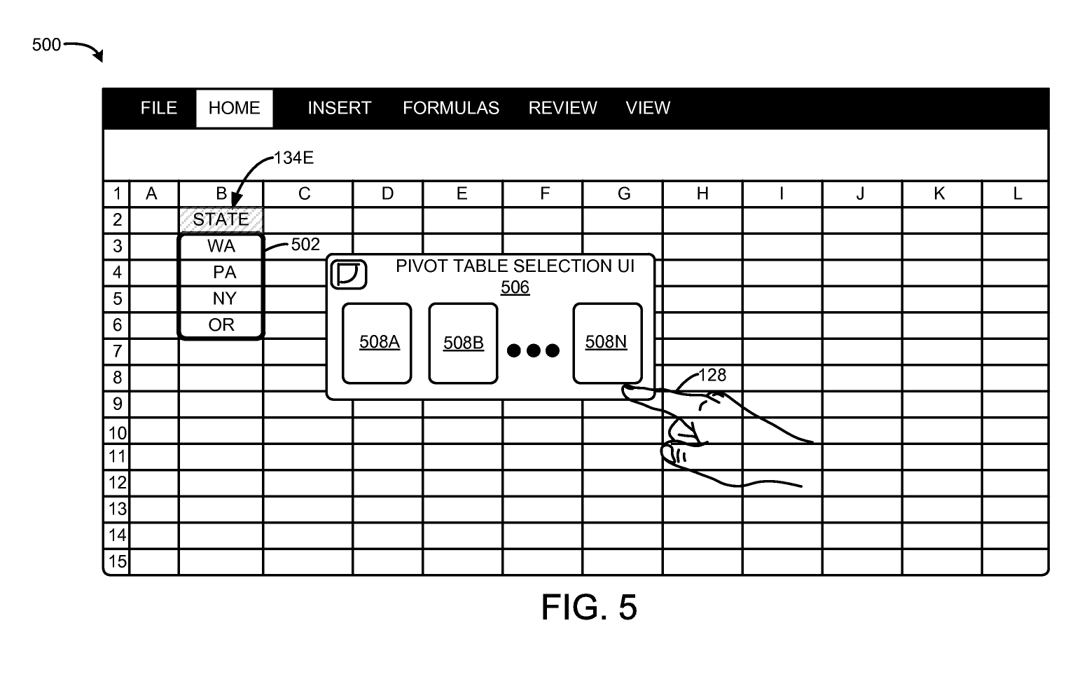

FIG. 5 is a user interface diagram showing a screen display 500 with more than one suggested application of obtained metadata. In some configurations, it may be valuable to present the user 128 with more than one suggested use of retrieved metadata 134. In FIG. 5, data 502 has been entered and selected by the user 128. The application 106 has invoked a search for metadata 134 to provide structure or description to the data 502. The metadata 134E returned may include one or more possible configurations. The application may select and apply the metadata 134E in one way, while also displaying other possible uses of the metadata 134E.

In the example illustrated in FIG. 5, the application 106 has displayed the metadata 134E as a column header for the data 502. Thus, in this use case, the application 106 has determined that the metadata 134E is to be utilized as a column header. But, it may be valuable for the user 128 (or other entity) to see other possible uses of the metadata 134E returned from the search.

If so configured, the application 106 may provide for various graphing or data organization tools, such as pivot table. In the example of the pivot table, the application may display a pivot table selection UI 506. The pivot table selection UI 506 may have rendered therein selectable alternate uses of the metadata 134E, illustrated as alternate use UI controls 508A-508N. The alternate use UI controls 508A-508N may represent different uses of the same metadata 134 E. The user 128 may select one or more of the alternate use UI controls 508A-508N.

Once selected, the application 106 may apply the use case associated with the selected alternate use UI control -508N to the data 502. In one specific example, the UI control 508A may be associated with use of the metadata 134E that organizes the entries under the column header “STATE.” If the UI control 508A is selected, the currently displayed configuration may be rendered in a manner to indicate acceptance. In this same example, the UI control 508B may represent an alternate use of the metadata 134E. For example, the UI control 508B may be associated with the use of the metadata 134E in which the metadata 134E also includes the full name of the entities. If selected, the UI control 508B may cause the application 106 to render a display in which the entries are changed from their abbreviated form to their unabbreviated form (e.g. WA->Washington). In another example, the UI control 508N may be associated with the use of the metadata 134E in which “STATE” is used as a row header rather than a column header. These and other examples are considered to be within the scope of the presently disclosed subject matter.

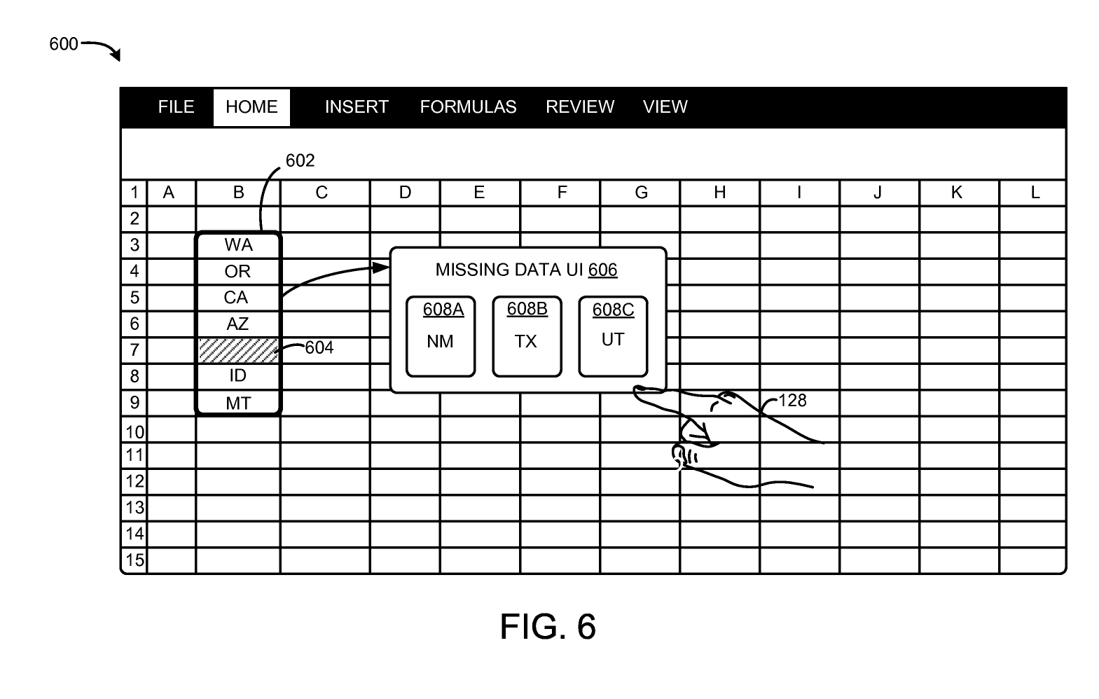

FIG. 6 is a user interface diagram showing a screen display 600 in which metadata is used to suggest missing data. In FIG. 6, the screen display 600 indicates that the user 128 has selected the data 602 for retrieval of metadata. In the implementation in FIG. 6, the metadata 134 returned as a result of the search may include the descriptive and/or structural metadata discussed previously. Further, the metadata returned as a result of the search may include missing data, either in addition to or in place of the descriptive and/or structural metadata. Missing data is data that is determined to likely be missing from the data 602, such as omitted data 604.

In response to determining that data is missing, the application 106 may display a missing data UI 606. The missing data UI 606 may be configured to display one or more missing data implementations 608A-608C. The application 106 may provide the user 128 with the ability to select the particular missing data implementation 608A-608C to input data in the omitted data 604.

In a specific example, in FIG. 6, a partial listing of states is shown. The application 106 may determine that an entry is missing (the omitted data 604). The application 106 may apply a search in an attempt to supplement the data 602 with metadata 134 that may correct the omission. After applying a search, the application 106 may display the missing data implementations 608A-608C. In this example, the missing data implementations 608A-608C may be abbreviated state entries that may be used to correct the omission. In the example illustrated in FIG. 6, the application 106 has performed a search on the data 602. The metadata 134 returned as a result of the search indicates that the data 602 is associated with western states in the United States of America. The metadata 134 may also provide additional state data as suggestions for the missing data. The suggestions may be presented as the missing data implementations 608A-608C, specifically, New Mexico (608A), Texas (608B), and Utah (608C).

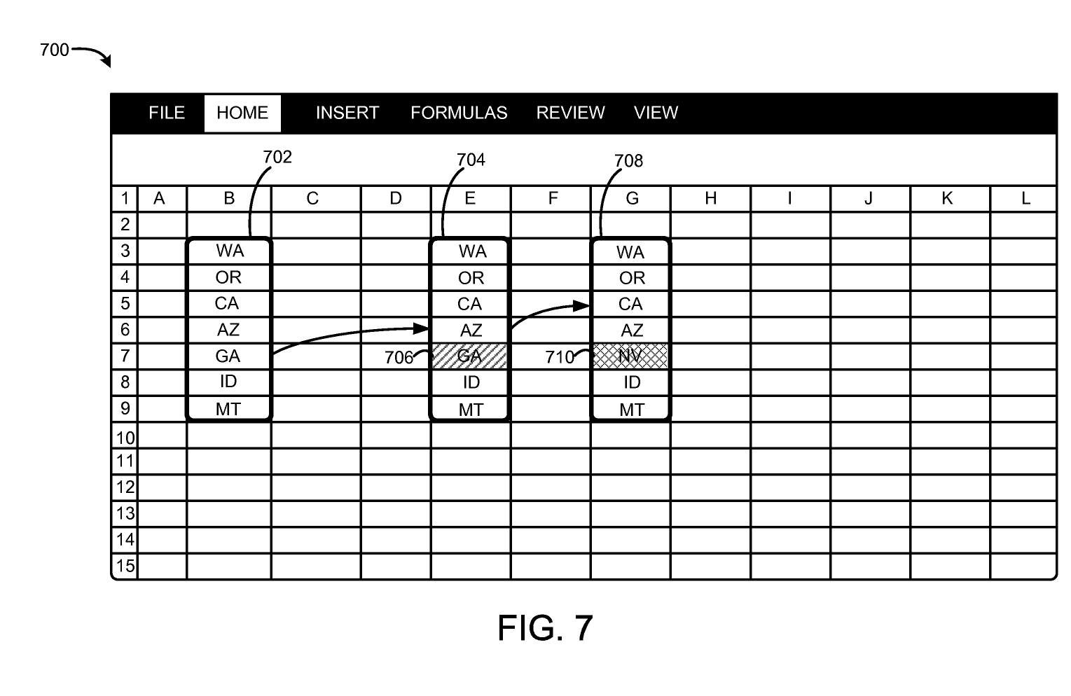

FIG. 7 is a user interface diagram showing a screen display 700 in which metadata may be used to correct data. In FIG. 7, the screen display 700 indicates that data 702 has been entered and selected. As a result of the search and retrieval of the metadata 134 in the manner described above, the application 106 may display data 704.

The data 704 includes the data 702, but the data point 706 is displayed in a manner that differentiates the data point 706 from the other data in the data 704. In particular, the data point 706 may be highlighted to indicate a possible error in the data 702. For example, the data 702 may be a listing of states associated with a specific United States court of appeals. The data point 706 may be associated with a state not associated with the same court of appeals. Thus, the application 106, after receiving the metadata 134, may use the metadata 134 to highlight anomalous or possibly incorrect data. Further, the application 106 may also provide a suggestion for correcting the error in the data, illustrated as data 708. The data 708 is the data 702 with the data point 706 (possibly an incorrect data point) substituted with data point 710. The data point 710 may be a state associated with the same court of appeals as the other states in the data 702.

Other types of anomalies may be detected in addition to the omissions or incorrect data examples described above. For example, a search may be performed on sales data. Metadata may be returned that indicates certain shopping or sales behaviors such as Christmas or other significant shopping dates. The metadata in these examples may be used to annotate sales data to possible explain anomalous sales data. These and other types of anomalies may be detected, annotated and/or explained using the metadata.

Various aspects of the presently disclosed subject matter may be considered in view of the following clauses:

Clause 1: A computer-implemented method comprising performing computer-implemented operations for:

receiving a selection of a portion of data used in a document, the data stored in a local data store;

generating a request to search a remote data store or an organizational data store for metadata associated with selected data;

receiving metadata from the remote data store or the organizational data store in response to the search, the metadata associated with the selected data; and

displaying suggested metadata from the received metadata in conjunction with the selected portion of the data.

Clause 2: The computer-implemented method of clause 1 and clauses 3-20, further comprising receiving an indication that that the suggested metadata is accepted.

Clause 3. The computer-implemented method of any of clauses 1, 2 and clauses 4-20, further comprising modifying a visual appearance of the suggested metadata to indicate an acceptance of the suggested metadata.

Clause 4. The computer-implemented method of any of clauses 1-3 and clauses 5-20, wherein the metadata comprises descriptive metadata that describes the selected data, structural metadata that provides information regarding a design or specification of the selected data, or a combination of descriptive and structural metadata.

Clause 5. The computer-implemented method of any of clauses 1-4 and clauses 6-20, further comprising displaying alternate uses of the metadata.

Clause 6. The computer-implemented method of any of clause 1-5 and clauses 7-20, further comprising receiving an input to place the selected data in a pivot table format based, at least in part, on the metadata.

Clause 7. The computer-implemented method of any of clauses 1-6 and clauses 8-20, wherein generating a request to search a remote data store or an organizational data store for metadata associated with selected data further comprises including a filter as a limiter on the metadata returned in response to the search.

Clause 8. The computer-implemented method of any of clauses 1-7 and clauses 9-20, wherein the filter is used to specify that the search be performed on a specific computer.

Clause 9. The computer-implemented method of any of clauses 1-8 and clauses 10-20, further comprising receiving metadata from the local data store in conjunction with the metadata from the remote data store or the organizational data store.

Clause 10. The computer-implemented method of any of clauses 1-9 and clauses 11-20, wherein the metadata comprises missing data in the selected data.

Clause 11. The computer-implemented method of any of clauses 1-10 and clauses 12-20, wherein the metadata comprises an indication of incorrect data in the selected data.

Clause 12. The computer-implemented method of any of clauses 1-11 and clauses 13-20, further comprising modifying a visual appearance of the selected data upon receipt of an approval of the suggested metadata.

Clause 13. A computer-readable storage medium having computer readable instructions stored thereupon that, when executed by a computer, cause the computer to:

receive a selection of a portion of data used in a document, the data stored in a local data store;

generate a request to search a remote data store or an organizational data store for metadata associated with selected data;

receive metadata from the remote data store or the organizational data store, the metadata associated with the selected data;

display suggested metadata identified from the received metadata;

receive an input to place the selected data in a pivot table format based on the suggested metadata; and

modify a visual appearance of the selected data upon receipt of an approval of the suggested metadata and the input to place the selected data in a pivot table format.

Clause 14. The computer-readable storage medium of any of clauses 13 and 15-20, further comprising instructions that cause the computer to receive an indication that the suggested metadata is accepted.

Clause 15. The computer-readable storage medium of any of clauses 13-14 and clauses 16-20, wherein the received metadata comprises descriptive metadata that describes the selected data, structural metadata that provides information regarding a design or specification of the selected data, or a combination of descriptive and structural metadata.

Clause 16. The computer-readable storage medium of any of clauses 13-15 and clauses 17-20, further comprising instructions that cause the computer to display alternate uses of the received metadata.

Clause 17. The computer-readable storage medium of any of clauses 13-16 and clauses 18-20, generate a request to search a remote data store or an organizational data store for metadata associated with selected data further comprises including a filter in the search as a limiter on the metadata to perform the search only on a specific computer.

Clause 18. The computer-readable storage medium of any of clauses 13-17 and clauses 19-20, further comprising instructions that cause the computer to receive metadata from the local data store in conjunction with the metadata from the remote data store or the organizational data store.

Clause 19. The computer-readable storage medium of any of clauses 13-18 and clause 20, wherein the metadata comprises missing data in the selected data or an indication of incorrect data in the selected data.

Clause 20. A system comprising:

a processor; and

a computer-readable storage medium in communication with the processor, the computer-readable storage medium having computer-executable instructions stored thereupon which, when executed by the processor, cause the processor to

receive a selection of a portion of data used in a document, the data stored in a local data store,

receive a request to search a remote data store or an organizational data store for metadata associated with selected data,

receive metadata from the remote data store or the organizational data store, the metadata associated with the selected data,

display suggested metadata from the received metadata,

receive an input to generate a pivot table based on the received metadata, and

modify a visual appearance of the selected data upon a receipt of an approval of the suggested metadata and the input to generate a pivot based on the received metadata.

FIG. 8 illustrates an illustrative computer architecture 800 for a device capable of executing the software components described herein for document data identification using a search. Thus, the computer architecture 800 illustrated in FIG. 8 illustrates an architecture for a server computer, mobile phone, a PDA, a smart phone, a desktop computer, a netbook computer, a tablet computer, and/or a laptop computer. The computer architecture 800 may be utilized to execute any aspects of the software components presented herein. For example, the computer architecture 800 might be utilized to implement the user device 102 described above with regard to FIG. 1.

The computer architecture 800 illustrated in FIG. 8 includes a central processing unit 802 (“CPU”), a system memory 804, including a random access memory 806 (“RAM”) and a read-only memory (“ROM”) 808, and a system bus 810 that couples the memory 804 to the CPU 802. A basic input/output system containing the basic routines that help to transfer information between elements within the computer architecture 800, such as during startup, is stored in the ROM 808. The computer architecture 800 further includes a mass storage device 812 for storing the operating system 104 and one or more application programs including, but not limited to, the application 106. The mass storage device 812 also can be configured to store data such as, for example, the local data 108.

The mass storage device 812 is connected to the CPU 802 through a mass storage controller (not shown) connected to the bus 810. The mass storage device 812 and its associated computer-readable media provide non-volatile storage for the computer architecture 800. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 800.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 800. For purposes the claims, a “computer storage medium” or “computer-readable storage medium,” and variations thereof, do not include waves, signals, and/or other transitory and/or intangible communication media, per se. For the purposes of the claims, “computer-readable storage medium,” and variations thereof, may refer to one or more types of articles of manufacture.

According to various examples or configurations, the computer architecture 800 may operate in a networked environment using logical connections to remote computers through a network such as the network 132. The computer architecture 800 may connect to the network 132 through a network interface unit 814 connected to the bus 810. It should be appreciated that the network interface unit 814 also may be utilized to connect to other types of networks and remote computer systems such as, for example, the remote computer 124. The computer architecture 800 also may include an input/output controller 816 for receiving and processing input from a number of other devices, including a keyboard, mouse, or electronic stylus (not shown in FIG. 8). Similarly, the input/output controller 816 may provide output to a display screen, a printer, or other type of output device (also not shown in FIG. 8).

It should be appreciated that the software components described herein may, when loaded into the CPU 802 and executed, transform the CPU 802 and the overall computer architecture 800 from a general-purpose computing system into a special-purpose computing system customized to facilitate the functionality presented herein. The CPU 802 may be constructed from any number of transistors or other discrete circuit elements, which may individually or collectively assume any number of states. More specifically, the CPU 802 may operate as a finite-state machine, in response to executable instructions contained within the software modules disclosed herein. These computer-executable instructions may transform the CPU 802 by specifying how the CPU 802 transitions between states, thereby transforming the transistors or other discrete hardware elements constituting the CPU 802.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 800 in order to store and execute the software components presented herein. It also should be appreciated that the computer architecture 800 may include other types of computing devices, including hand-held computers, embedded computer systems, personal digital assistants, and other types of computing devices known to those skilled in the art. It is also contemplated that the computer architecture 800 may not include all of the components shown in FIG. 8, may include other components that are not explicitly shown in FIG. 8, or may utilize an architecture completely different than that shown in FIG. 8.

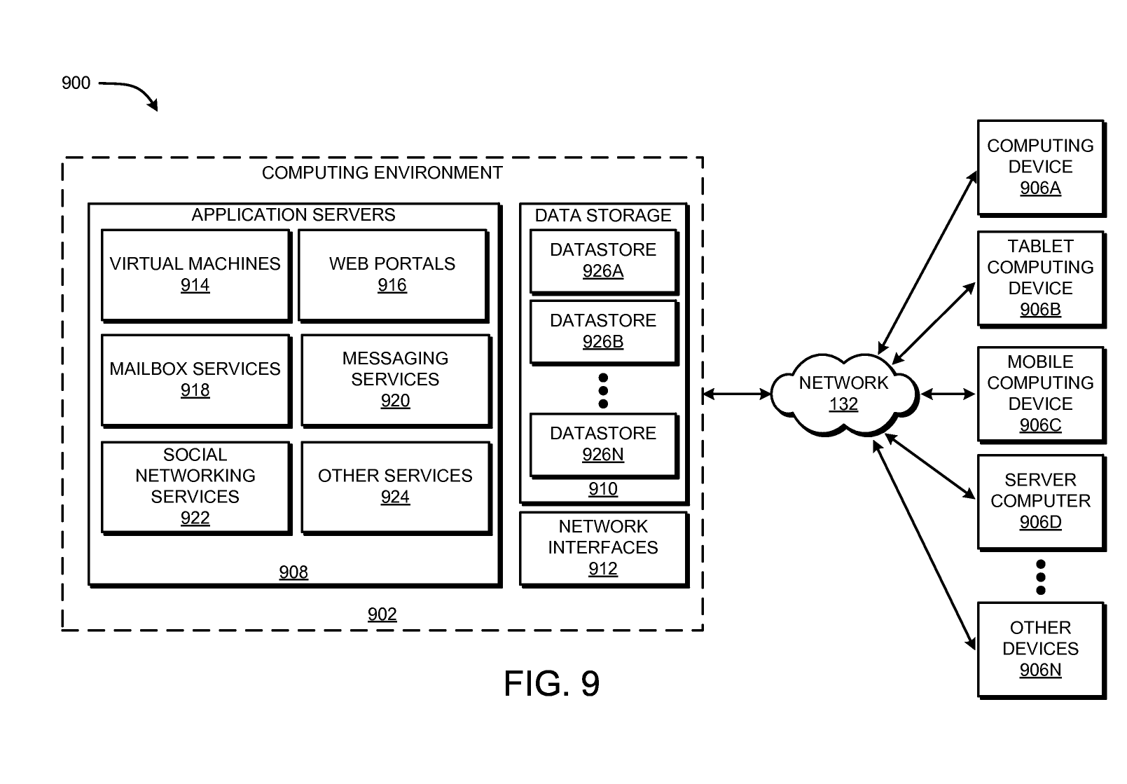

FIG. 9 shows an illustrative distributed computing environment 900 capable of executing the software components described herein for document data identification using a search. Thus, the distributed computing environment 900 illustrated in FIG. 9 can be used to provide the functionality described herein with respect to the user device 102, the organization computer 118, and/or the remote computer 124. The distributed computing environment 900 thus may be utilized to execute any aspects of the software components presented herein.

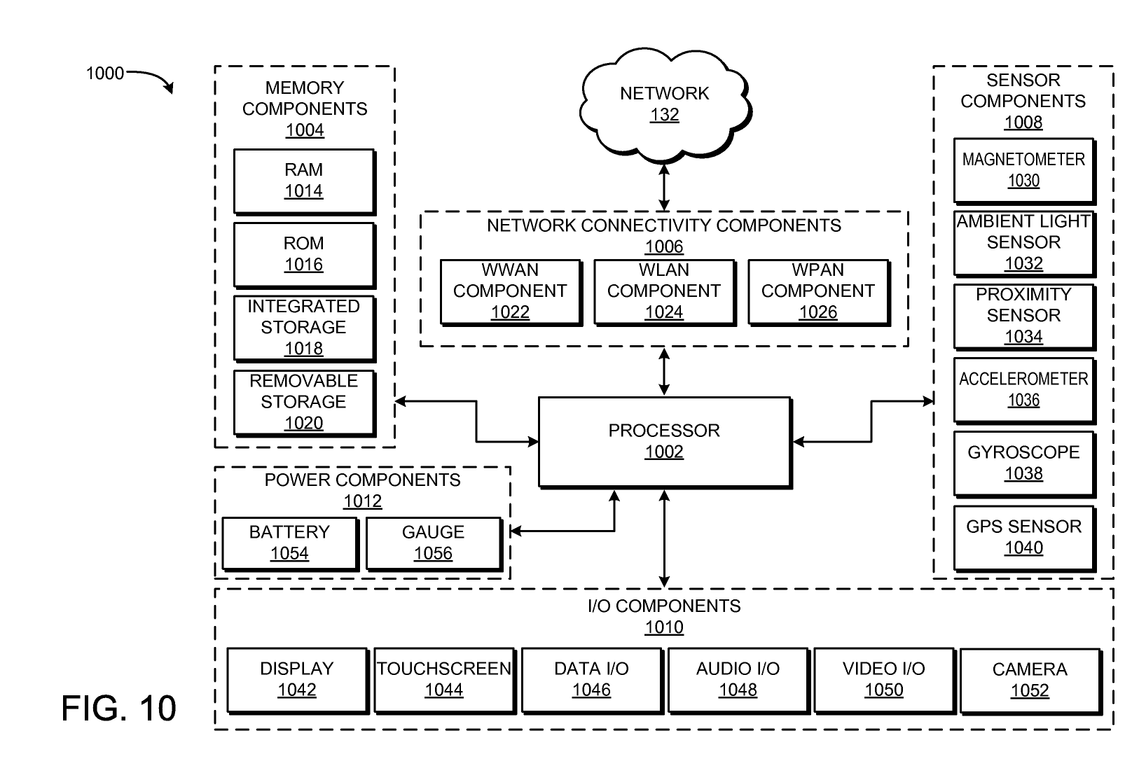

According to various implementations, the distributed computing environment 900 includes a computing environment 902 operating on, in communication with, or as part of the network 904. The network 904 also can include various access networks. According to various implementations, the functionality of the network 904 is provided by the network 132 illustrated in FIG. 1. One or more client devices 906A-906N (hereinafter referred to collectively and/or generically as “clients 906”) can communicate with the computing environment 902 via the network 904 and/or other connections (not illustrated in FIG. 9). In the illustrated configuration, the clients 906 include a computing device 906A such as a laptop computer, a desktop computer, or other computing device; a slate or tablet computing device (“tablet computing device”) 906B; a mobile computing device 906C such as a mobile telephone, a smart phone, or other mobile computing device; a server computer 906D; and/or other devices 906N. It should be understood that any number of clients 906 can communicate with the computing environment 902. Two example computing architectures for the clients 906 are illustrated and described herein with reference to FIGS. 8 and 10. It should be understood that the illustrated clients 906 and computing architectures illustrated and described herein are illustrative, and should not be construed as being limited in any way.

In the illustrated configuration, the computing environment 902 includes application servers 908, data storage 910, and one or more network interfaces 912. According to various implementations, the functionality of the application servers 908 can be provided by one or more server computers that are executing as part of, or in communication with, the network 904. The application servers 908 can host various services, virtual machines, portals, and/or other resources. In the illustrated configuration, the application servers 908 host one or more virtual machines 914 for hosting applications or other functionality. According to various implementations, the virtual machines 914 host one or more applications and/or software modules for providing the functionality described herein for document data identification using a search. It should be understood that this configuration is illustrative, and should not be construed as being limiting in any way. The application servers 908 also host or provide access to one or more Web portals, link pages, Web sites, and/or other information (“Web portals”) 916.

According to various implementations, the application servers 908 also include one or more mailbox services 918 and one or more messaging services 920. The mailbox services 918 can include electronic mail (“email”) services. The mailbox services 918 also can include various personal information management (“PIM”) services including, but not limited to, calendar services, contact management services, collaboration services, and/or other services. The messaging services 920 can include, but are not limited to, instant messaging services, chat services, forum services, and/or other communication services.

The application servers 908 also can include one or more social networking services 922. The social networking services 922 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 922 are provided by or include the FACEBOOK social networking service, the LINKEDIN professional networking service, the MYSPACE social networking service, the FOURSQUARE geographic networking service, the YAMMER office colleague networking service, and the like.

In other configurations, the social networking services 922 are provided by other services, sites, and/or providers that may or may not explicitly be known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 922 also can include commenting, blogging, and/or microblogging services. Examples of such services include, but are not limited to, the YELP commenting service, the KUDZU review service, the OFFICETALK enterprise microblogging service, the TWITTER messaging service, the GOOGLE BUZZ service, and/or other services. It should be appreciated that the above lists of services are not exhaustive and that numerous additional and/or alternative social networking services 922 are not mentioned herein for the sake of brevity. As such, the above configurations are illustrative, and should not be construed as being limited in any way.

As shown in FIG. 9, the application servers 908 also can host other services, applications, portals, and/or other resources (“other resources”) 924. The other resources 924 can include, but are not limited to, the application 106. It therefore can be appreciated that the computing environment 902 can provide integration of the concepts and technologies disclosed herein provided herein for document data identification using a search with various mailbox, messaging, social networking, and/or other services or resources.

As mentioned above, the computing environment 902 can include the data storage 910. According to various implementations, the functionality of the data storage 910 is provided by one or more databases operating on, or in communication with, the network 904. The functionality of the data storage 910 also can be provided by one or more server computers configured to host data for the computing environment 902. The data storage 910 can include, host, or provide one or more real or virtual datastores 926A-926N (hereinafter referred to collectively and/or generically as “datastores 926”). The datastores 926 are configured to host data used or created by the application servers 908 and/or other data. Although not illustrated in FIG. 9, the datastores 926 also can host or store the local data 108, if desired.

The computing environment 902 can communicate with, or be accessed by, the network interfaces 912. The network interfaces 912 can include various types of network hardware and software for supporting communications between two or more computing devices including, but not limited to, the clients 906 and the application servers 908. It should be appreciated that the network interfaces 912 also may be utilized to connect to other types of networks and/or computer systems.

It should be understood that the distributed computing environment 900 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 900 provides the software functionality described herein as a service to the clients 906. It should be understood that the clients 906 can include real or virtual machines including, but not limited to, server computers, web servers, personal computers, mobile computing devices, smart phones, and/or other devices. As such, various configurations of the concepts and technologies disclosed herein enable any device configured to access the distributed computing environment 900 to utilize the functionality described herein for document data identification using a search.

Turning now to FIG. 10, an illustrative computing device architecture 1000 for a computing device that is capable of executing various software components described herein for document data identification using a search. The computing device architecture 1000 is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like.

Moreover, the computing device architecture 1000 is applicable to any of the clients 1006 shown in FIG. 9. Furthermore, aspects of the computing device architecture 1000 may be applicable to traditional desktop computers, portable computers (e.g., laptops, notebooks, ultra-portables, and netbooks), server computers, and other computer systems, such as described herein with reference to FIG. 8. For example, the single touch and multi-touch aspects disclosed herein below may be applied to desktop computers that utilize a touchscreen or some other touch-enabled device, such as a touch-enabled track pad or touch-enabled mouse.

The computing device architecture 1000 illustrated in FIG. 10 includes a processor 1002, memory components 1004, network connectivity components 1006, sensor components 1008, input/output components 1010, and power components 1012. In the illustrated configuration, the processor 1002 is in communication with the memory components 1004, the network connectivity components 1006, the sensor components 1008, the input/output (“I/O”) components 1010, and the power components 1012. Although no connections are shown between the individuals components illustrated in FIG. 10, the components can interact to carry out device functions. In some configurations, the components are arranged so as to communicate via one or more busses (not shown).

The processor 1002 includes a central processing unit (“CPU”) configured to process data, execute computer-executable instructions of one or more application programs, and communicate with other components of the computing device architecture 1000 in order to perform various functionality described herein. The processor 1002 may be utilized to execute aspects of the software components presented herein and, particularly, those that utilize, at least in part, a touch-enabled input.

In some configurations, the processor 1002 includes a graphics processing unit (“GPU”) configured to accelerate operations performed by the CPU, including, but not limited to, operations performed by executing general-purpose scientific and engineering computing applications, as well as graphics-intensive computing applications such as high resolution video (e.g., 720P, 1080P, and greater), video games, three-dimensional (“3D”) modeling applications, and the like. In some configurations, the processor 1002 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some configurations, the processor 1002 is, or is included in, a system-on-chip (“SoC”) along with one or more of the other components described herein below. For example, the SoC may include the processor 1002, a GPU, one or more of the network connectivity components 1006, and one or more of the sensor components 1008. In some configurations, the processor 1002 is fabricated, in part, utilizing a package-on-package (“PoP”) integrated circuit packaging technique. Moreover, the processor 1002 may be a single core or multi-core processor.

The processor 1002 may be created in accordance with an ARM architecture, available for license from ARM HOLDINGS of Cambridge, United Kingdom. Alternatively, the processor 1002 may be created in accordance with an x86 architecture, such as is available from INTEL CORPORATION of Mountain View, Calif. and others. In some configurations, the processor 1002 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 1004 include a random access memory (“RAM”) 1014, a read-only memory (“ROM”) 1016, an integrated storage memory (“integrated storage”) 1018, and a removable storage memory (“removable storage”) 1020. In some configurations, the RAM 1014 or a portion thereof, the ROM 1016 or a portion thereof, and/or some combination the RAM 1014 and the ROM 1016 is integrated in the processor 1002. In some configurations, the ROM 1016 is configured to store a firmware, an operating system or a portion thereof (e.g., operating system kernel), and/or a bootloader to load an operating system kernel from the integrated storage 1018 or the removable storage 1020.

The integrated storage 1018 can include a solid-state memory, a hard disk, or a combination of solid-state memory and a hard disk. The integrated storage 1018 may be soldered or otherwise connected to a logic board upon which the processor 1002 and other components described herein also may be connected. As such, the integrated storage 1018 is integrated in the computing device. The integrated storage 1018 is configured to store an operating system or portions thereof, application programs, data, and other software components described herein.

The removable storage 1020 can include a solid-state memory, a hard disk, or a combination of solid-state memory and a hard disk. In some configurations, the removable storage 1020 is provided in lieu of the integrated storage 1018. In other configurations, the removable storage 1020 is provided as additional optional storage. In some configurations, the removable storage 1020 is logically combined with the integrated storage 1018 such that the total available storage is made available and shown to a user as a total combined capacity of the integrated storage 1018 and the removable storage 1020.

The removable storage 1020 is configured to be inserted into a removable storage memory slot (not shown) or other mechanism by which the removable storage 1020 is inserted and secured to facilitate a connection over which the removable storage 1020 can communicate with other components of the computing device, such as the processor 1002. The removable storage 1020 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 1004 can store an operating system. According to various configurations, the operating system includes, but is not limited to, SYMBIAN OS from SYMBIAN LIMITED, WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 1006 include a wireless wide area network component (“WWAN component”) 1022, a wireless local area network component (“WLAN component”) 1024, and a wireless personal area network component (“WPAN component”) 1026. The network connectivity components 1006 facilitate communications to and from a network 132, which may be a WWAN, a WLAN, or a WPAN. Although a single network 132 is illustrated, the network connectivity components 1006 may facilitate simultaneous communication with multiple networks. For example, the network connectivity components 1006 may facilitate simultaneous communications with multiple networks via one or more of a WWAN, a WLAN, or a WPAN.

The network 132 may be a WWAN, such as a mobile telecommunications network utilizing one or more mobile telecommunications technologies to provide voice and/or data services to a computing device utilizing the computing device architecture 1000 via the WWAN component 1022. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 132 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 132 may be configured to provide voice and/or data communications with any combination of the above technologies. The network 132 may be configured to or adapted to provide voice and/or data communications in accordance with future generation technologies.

In some configurations, the WWAN component 1022 is configured to provide dual- multi-mode connectivity to the network 132. For example, the WWAN component 1022 may be configured to provide connectivity to the network 132, wherein the network 132 provides service via GSM and UMTS technologies, or via some other combination of technologies. Alternatively, multiple WWAN components 1022 may be utilized to perform such functionality, and/or provide additional functionality to support other non-compatible technologies (i.e., incapable of being supported by a single WWAN component). The WWAN component 1022 may facilitate similar connectivity to multiple networks (e.g., a UMTS network and an LTE network).

The network 132 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 1024 is configured to connect to the network 132 via the WI-FI access points. Such connections may be secured via various encryption technologies including, but not limited, WI-FI Protected Access (“WPA”), WPA2, Wired Equivalent Privacy (“WEP”), and the like.

The network 132 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 1026 is configured to facilitate communications with other devices, such as peripherals, computers, or other computing devices via the WPAN.

The sensor components 1008 include a magnetometer 1030, an ambient light sensor 1032, a proximity sensor 1034, an accelerometer 1036, a gyroscope 1038, and a Global Positioning System sensor (“GPS sensor”) 1040. It is contemplated that other sensors, such as, but not limited to, temperature sensors or shock detection sensors, also may be incorporated in the computing device architecture 1000.

The magnetometer 1030 is configured to measure the strength and direction of a magnetic field. In some configurations the magnetometer 1030 provides measurements to a compass application program stored within one of the memory components 1004 in order to provide a user with accurate directions in a frame of reference including the cardinal directions, north, south, east, and west. Similar measurements may be provided to a navigation application program that includes a compass component. Other uses of measurements obtained by the magnetometer 1030 are contemplated.

The ambient light sensor 1032 is configured to measure ambient light. In some configurations, the ambient light sensor 1032 provides measurements to an application program stored within one the memory components 1004 in order to automatically adjust the brightness of a display (described below) to compensate for low-light and high-light environments. Other uses of measurements obtained by the ambient light sensor 1032 are contemplated.

The proximity sensor 1034 is configured to detect the presence of an object or thing in proximity to the computing device without direct contact. In some configurations, the proximity sensor 1034 detects the presence of a user's body (e.g., the user's face) and provides this information to an application program stored within one of the memory components 1004 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 1034 are contemplated.

The accelerometer 1036 is configured to measure proper acceleration. In some configurations, output from the accelerometer 1036 is used by an application program as an input mechanism to control some functionality of the application program. For example, the application program may be a video game in which a character, a portion thereof, or an object is moved or otherwise manipulated in response to input received via the accelerometer 1036. In some configurations, output from the accelerometer 1036 is provided to an application program for use in switching between landscape and portrait modes, calculating coordinate acceleration, or detecting a fall. Other uses of the accelerometer 1036 are contemplated.

The gyroscope 1038 is configured to measure and maintain orientation. In some configurations, output from the gyroscope 1038 is used by an application program as an input mechanism to control some functionality of the application program. For example, the gyroscope 1038 can be used for accurate recognition of movement within a 3D environment of a video game application or some other application. In some configurations, an application program utilizes output from the gyroscope 1038 and the accelerometer 1036 to enhance control of some functionality of the application program. Other uses of the gyroscope 1038 are contemplated.

The GPS sensor 1040 is configured to receive signals from GPS satellites for use in calculating a location. The location calculated by the GPS sensor 1040 may be used by any application program that requires or benefits from location information. For example, the location calculated by the GPS sensor 1040 may be used with a navigation application program to provide directions from the location to a destination or directions from the destination to the location. Moreover, the GPS sensor 1040 may be used to provide location information to an external location-based service, such as E911 service. The GPS sensor 1040 may obtain location information generated via WI-FI, WIMAX, and/or cellular triangulation techniques utilizing one or more of the network connectivity components 1006 to aid the GPS sensor 1040 in obtaining a location fix. The GPS sensor 1040 may also be used in Assisted GPS (“A-GPS”) systems.

The I/O components 1010 include a display 1042, a touchscreen 1044, a data I/O interface component (“data I/O”) 1046, an audio I/O interface component (“audio I/O”) 1048, a video I/O interface component (“video I/O”) 1050, and a camera 1052. In some configurations, the display 1042 and the touchscreen 1044 are combined. In some configurations two or more of the data I/O component 1046, the audio I/O component 1048, and the video I/O component 1050 are combined. The I/O components 1010 may include discrete processors configured to support the various interface described below, or may include processing functionality built-in to the processor 1002.

The display 1042 is an output device configured to present information in a visual form. In particular, the display 1042 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 1042 is a liquid crystal display (“LCD”) utilizing any active or passive matrix technology and any backlighting technology (if used). In some configurations, the display 1042 is an organic light emitting diode (“OLED”) display. Other display types are contemplated.

The touchscreen 1044 is an input device configured to detect the presence and location of a touch. The touchscreen 1044 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some configurations, the touchscreen 1044 is incorporated on top of the display 1042 as a transparent layer to enable a user to use one or more touches to interact with objects or other information presented on the display 1042. In other configurations, the touchscreen 1044 is a touch pad incorporated on a surface of the computing device that does not include the display 1042. For example, the computing device may have a touchscreen incorporated on top of the display 1042 and a touch pad on a surface opposite the display 1042.

In some configurations, the touchscreen 1044 is a single-touch touchscreen. In other configurations, the touchscreen 1044 is a multi-touch touchscreen. In some configurations, the touchscreen 1044 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 1044. As such, a developer may create gestures that are specific to a particular application program.

In some configurations, the touchscreen 1044 supports a tap gesture in which a user taps the touchscreen 1044 once on an item presented on the display 1042. The tap gesture may be used for various reasons including, but not limited to, opening or launching whatever the user taps. In some configurations, the touchscreen 1044 supports a double tap gesture in which a user taps the touchscreen 1044 twice on an item presented on the display 1042. The double tap gesture may be used for various reasons including, but not limited to, zooming in or zooming out in stages. In some configurations, the touchscreen 1044 supports a tap and hold gesture in which a user taps the touchscreen 1044 and maintains contact for at least a pre-defined time. The tap and hold gesture may be used for various reasons including, but not limited to, opening a context-specific menu.

In some configurations, the touchscreen 1044 supports a pan gesture in which a user places a finger on the touchscreen 1044 and maintains contact with the touchscreen 1044 while moving the finger on the touchscreen 1044. The pan gesture is also referred to above with reference to FIGS. 1-3E as a tap-drag gesture. The pan gesture may be used for various reasons including, but not limited to, moving through screens, images, or menus at a controlled rate and/or indicating a command to pan or move or select the displayed local data 108. Multiple finger pan gestures are also contemplated. In some configurations, the touchscreen 1044 supports a flick gesture in which a user swipes a finger in the direction the user wants the screen to move. The flick gesture may be used for various reasons including, but not limited to, scrolling horizontally or vertically through menus or pages. In some configurations, the touchscreen 1044 supports a pinch and stretch gesture in which a user makes a pinching motion with two fingers (e.g., thumb and forefinger) on the touchscreen 1044 or moves the two fingers apart. The pinch and stretch gesture may be used for various reasons including, but not limited to, zooming gradually in or out of a website, map, or picture.

Although the above gestures have been described with reference to the use one or more fingers for performing the gestures, other appendages such as toes or objects such as styluses may be used to interact with the touchscreen 1044. As such, the above gestures should be understood as being illustrative and should not be construed as being limiting in any way.

The data I/O interface component 1046 is configured to facilitate input of data to the computing device and output of data from the computing device. In some configurations, the data I/O interface component 1046 includes a connector configured to provide wired connectivity between the computing device and a computer system, for example, for synchronization operation purposes. The connector may be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 1048 is configured to provide audio input and/or output capabilities to the computing device. In some configurations, the audio I/O interface component 1046 includes a microphone configured to collect audio signals. In some configurations, the audio I/O interface component 1046 includes a headphone jack configured to provide connectivity for headphones or other external speakers. In some configurations, the audio interface component 1048 includes a speaker for the output of audio signals. In some configurations, the audio I/O interface component 1046 includes an optical audio cable out.

The video I/O interface component 1050 is configured to provide video input and/or output capabilities to the computing device. In some configurations, the video I/O interface component 1050 includes a video connector configured to receive video as input from another device (e.g., a video media player such as a DVD or BLURAY player) or send video as output to another device (e.g., a monitor, a television, or some other external display). In some configurations, the video I/O interface component 1050 includes a High-Definition Multimedia Interface (“HDMI”), mini-HDMI, micro-HDMI, DisplayPort, or proprietary connector to input/output video content. In some configurations, the video I/O interface component 1050 or portions thereof is combined with the audio I/O interface component 1048 or portions thereof.

The camera 1052 can be configured to capture still images and/or video. The camera 1052 may utilize a charge coupled device (“CCD”) or a complementary metal oxide semiconductor (“CMOS”) image sensor to capture images. In some configurations, the camera 1052 includes a flash to aid in taking pictures in low-light environments. Settings for the camera 1052 may be implemented as hardware or software buttons.

Although not illustrated, one or more hardware buttons may also be included in the computing device architecture 1000. The hardware buttons may be used for controlling some operational aspect of the computing device. The hardware buttons may be dedicated buttons or multi-use buttons. The hardware buttons may be mechanical or sensor-based.

The illustrated power components 1012 include one or more batteries 1054, which can be connected to a battery gauge 1056. The batteries 1054 may be rechargeable or disposable. Rechargeable battery types include, but are not limited to, lithium polymer, lithium ion, nickel cadmium, and nickel metal hydride. Each of the batteries 1054 may be made of one or more cells.

The battery gauge 1056 can be configured to measure battery parameters such as current, voltage, and temperature. In some configurations, the battery gauge 1056 is configured to measure the effect of a battery's discharge rate, temperature, age and other factors to predict remaining life within a certain percentage of error. In some configurations, the battery gauge 1056 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 1012 may also include a power connector, which may be combined with one or more of the aforementioned I/O components 1010. The power components 1012 may interface with an external power system or charging equipment via a power I/O component.

Based on the foregoing, it should be appreciated that technologies for leveraging data searching in a document have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example configurations and applications illustrated and described, and without departing from the true spirit and scope of the present invention, which is set forth in the following claims.

What is claimed is:

1. A computer-implemented method comprising performing computer-implemented operations for:
receiving a selection of a portion of data used in a document, the data stored in a local data store;
generating a request to search a remote data store or an organizational data store for metadata associated with selected data;
receiving metadata from the remote data store or the organizational data store in response to the search, the metadata associated with the selected data; and
displaying suggested metadata from the received metadata in conjunction with the selected portion of the data.

2. The computer-implemented method of claim 1, further comprising receiving an indication that that the suggested metadata is accepted.

3. The computer-implemented method of claim 2, further comprising modifying a visual appearance of the suggested metadata to indicate an acceptance of the suggested metadata.

4. The computer-implemented method of claim 1, wherein the metadata comprises descriptive metadata that describes the selected data, structural metadata that provides information regarding a design or specification of the selected data, or a combination of descriptive and structural metadata.

5. The computer-implemented method of claim 1, further comprising displaying alternate uses of the metadata.

6. The computer-implemented method of claim 1, further comprising receiving an input to place the selected data in a pivot table format based, at least in part, on the metadata.

7. The computer-implemented method of claim 1, wherein generating a request to search a remote data store or an organizational data store for metadata associated with selected data further comprises including a filter as a limiter on the metadata returned in response to the search.

8. The computer-implemented method of claim 7, wherein the filter is used to specify that the search be performed on a specific computer.

9. The computer-implemented method of claim 1, further comprising receiving metadata from the local data store in conjunction with the metadata from the remote data store or the organizational data store.

10. The computer-implemented method of claim 1, wherein the metadata comprises missing data in the selected data.

11. The computer-implemented method of claim 1, wherein the metadata comprises an indication of incorrect data in the selected data.

12. The computer-implemented method of claim 1, further comprising modifying a visual appearance of the selected data upon receipt of an approval of the suggested metadata.

13. A computer-readable storage medium having computer readable instructions stored thereupon that, when executed by a computer, cause the computer to:
receive a selection of a portion of data used in a document, the data stored in a local data store;
generate a request to search a remote data store or an organizational data store for metadata associated with selected data;
receive metadata from the remote data store or the organizational data store, the metadata associated with the selected data;
display suggested metadata identified from the received metadata;
receive an input to place the selected data in a pivot table format based on the suggested metadata; and
modify a visual appearance of the selected data upon receipt of an approval of the suggested metadata and the input to place the selected data in a pivot table format.

14. The computer-readable storage medium of claim 13, further comprising instructions that cause the computer to receive an indication that the suggested metadata is accepted.

15. The computer-readable storage medium of claim 13, wherein the received metadata comprises descriptive metadata that describes the selected data, structural metadata that provides information regarding a design or specification of the selected data, or a combination of descriptive and structural metadata.

16. The computer-readable storage medium of claim 13, further comprising instructions that cause the computer to display alternate uses of the received metadata.

17. The computer-readable storage medium of claim 13, generate a request to search a remote data store or an organizational data store for metadata associated with selected data further comprises including a filter in the search as a limiter on the metadata to perform the search only on a specific computer.

18. The computer-readable storage medium of claim 13, further comprising instructions that cause the computer to receive metadata from the local data store in conjunction with the metadata from the remote data store or the organizational data store.

19. The computer-readable storage medium of claim 13, wherein the metadata comprises missing data in the selected data or an indication of incorrect data in the selected data.

20. A system comprising:
a processor; and
a computer-readable storage medium in communication with the processor, the computer-readable storage medium having computer-executable instructions stored thereupon which, when executed by the processor, cause the processor to
receive a selection of a portion of data used in a document, the data stored in a local data store,
search a remote data store or an organizational data store for metadata associated with selected data,
receive metadata from the remote data store or the organizational data store, the metadata associated with the selected data,
display suggested metadata from the received metadata,
receive an input to generate a pivot table based on the received metadata, and modify a visual appearance of the selected data upon a receipt of an approval of the suggested metadata and the input to generate a pivot based on the received metadata.
